(19) United States
(12) Patent Application Publication
(10) Pub. No.: US 2011/0271793 A1
(43) Pub. Date: Nov. 10, 2011

(54) COVER AND ACTUATOR

(76) Inventor: Kenta Hatano, Tokyo (JP)

(21) Appl. No.: 13/145,527

(22) PCT Filed: May 19, 2009
(86) PCT No.: PCT/JP2009/002205

§ 371 Date: Jul. 20, 2011

(51) Int. Cl. F16P 1/00

(52) U.S. Cl. 74/608

(57) ABSTRACT

A cover ASSY 12 attached to a shaft 9 of a linear actuator 1 includes a nut 12b to be screwed on a male screw section 9b formed at the lower end of the shaft 9; a bottomed cylindrical cover body 12a for protecting a boot 10; and a plate 12c, and the ASSY is constructed such that the bottom of the cover body 12a is welded in a sandwich structure with the plate 12c and the nut 12b.

### TECHNICAL FIELD

The present invention relates to a heat-shielding and screening cover to be attached to a shaft of a linear actuator.

### BACKGROUND ART

Conventionally, a cover is attached to an actuator to surround a shaft (output shaft) in order to prevent the entry of water, dust and so on from the shaft to the actuator (see Patent Document 1, for example).

A cover attached to a shaft will next be explained with a linear or translation-type actuator using an electrically controlled motor, by way of one example of an actuator. FIG. 3 is a sectional view showing a structure of a linear actuator 1 and a conventional cover ASSY (assembly) 91 attached to a shaft 9 thereof. The cover ASSY 91 consists of a cover body 91a and a weld nut 91b as shown in FIG. 4; FIG. 4(a) shows a state where the weld nut 91b and the cover body 91a are not yet welded to each other, and FIG. 4(b) shows a state where the weld nut 91b and the cover body 91a have been welded to each other. As in the actuator 1 shown in FIG. 3 a voltage is applied to a terminal 3 equipped in an external input/output connector 2 thereof, current flows in a coil 5 wound around a stator 4, and thereby the stator 4 polarized into a plurality of poles is NS magnetized. A cylindrical rotor 8, which includes an NS magnetized magnet 6 and of which each end is held by a bearing 7, is rotated by the NS magnetization of the stator 4. In the interior of the rotor 8, a screw mechanism 8a for converting rotary motion into linear motion is formed, and the screw mechanism 8a meshes with a screw mechanism 9a formed on the side of the shaft 9 to thereby convert the rotation movement of the rotor 8 into the reciprocating movement of the shaft 9. It is to be noted that a rotation restraining mechanism of the screw mechanism 8a is also provided in the shaft 9 and a boss 11 for pivotally supporting the shaft 9 in a translatable manner.

As shown in FIG. 3, in order to prevent the entry of water, dust and so on into the interior of the actuator 1 through a gap between the shaft 9 and the boss 11, a boot 10 is attached to the shaft 9 so as to cover the gap between the shaft 9 and the boss 11. In general, the boot 10 is made of a material such as rubber. Therefore, in order to protect the boot 10 against damage by heat and foreign matter such as stone and prevent the entry of foreign matter into the inside of the actuator 1, the cover ASSY 91 is attached to the shaft 9. As shown in FIG. 4, the conventional cover ASSY 91 is constructed by welding the weld nut 91b having a welding protrusion 91b-1 to the cover body 91a made of sheet-metal to be further brazed.

The cover ASSY 91 is fastened around the shaft 9 by screwing the weld nut 91b on a male screw section formed by externally threading the lower end portion of the shaft and further screwing a nut 14 on the screw section at one end of a joint 13. A driven portion 15 is connected to the other end of the joint 13.

### PRIOR ART DOCUMENTS

### Patent Documents

Patent Document 1: JP-A-2001-263055

The conventional cover ASSY 91 is attached by screwing the weld nut 91b thereof at the end portion of the shaft 9, and the cover ASSY 91 is translated together with the shaft 9. Thus, there is a problem such that a connection 92 between the cover body 91a and the weld nut 91b is damaged by vibration.

The present invention has been made to solve the above-mentioned problem, and an object of the present invention is to provide a heat-shielding and screening having improved vibration resistance.

### SUMMARY OF THE INVENTION

A cover according to the present invention includes a nut to be screwed on a male screw section formed at an end of a shaft of an actuator; a bottomed cylindrical cover body; and a plate, wherein the bottom of the cover body is integrated with the plate and the nut in a sandwich structure.

According to the present invention, the cover body is arranged to have an integrated structure sandwiched between the plate and the nut, thereby enhancing the vibration resistance thereof.

### BRIEF DESCRIPTION OF THE DRAWINGS

FIG. 1 shows the structure of a linear actuator and a cover ASSY attached to a shaft of the actuator, according to the first embodiment of the present invention: FIG. 1(a) is a sectional view thereof, and FIG. 1(b) is a front view of a connection portion thereof.

FIG. 2 shows the structure of the cover ASSY shown in FIG. 1: FIG. 2(a) shows a sectional view thereof before welding; FIG. 2(b) shows a sectional view thereof after welding; and FIG. 2(c) shows a plan view of the bottom of a cover body.

FIG. 3 is a sectional view showing the structure of a linear actuator and a conventional cover ASSY attached to a shaft thereof.

FIG. 4 is a sectional view showing the structure of the conventional cover ASSY shown in FIG. 3: FIG. 4(a) shows a state thereof before welding; and FIG. 4(b) shows a state thereof after welding.

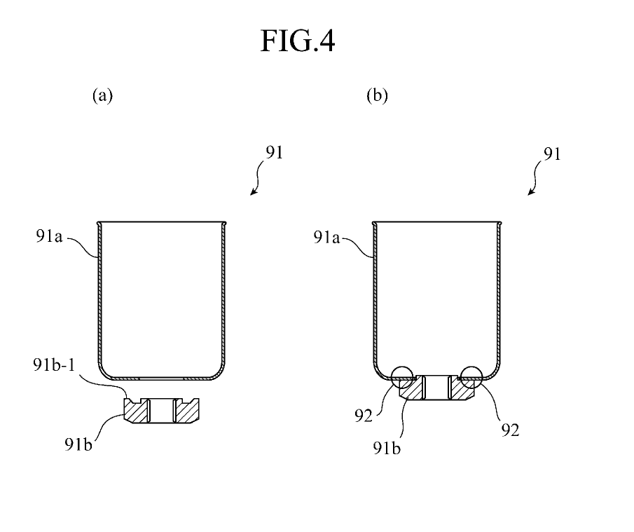

### BEST MODE FOR CARRYING OUT THE INVENTION

Embodiments of the present invention will now be described with reference to the accompanying drawings in order to explain the present invention in more detail.

### First Embodiment

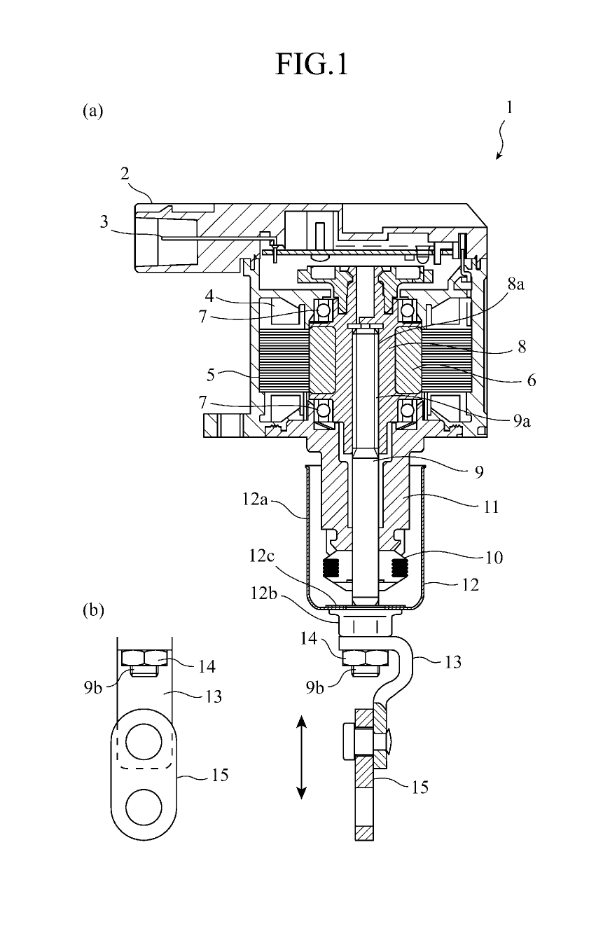

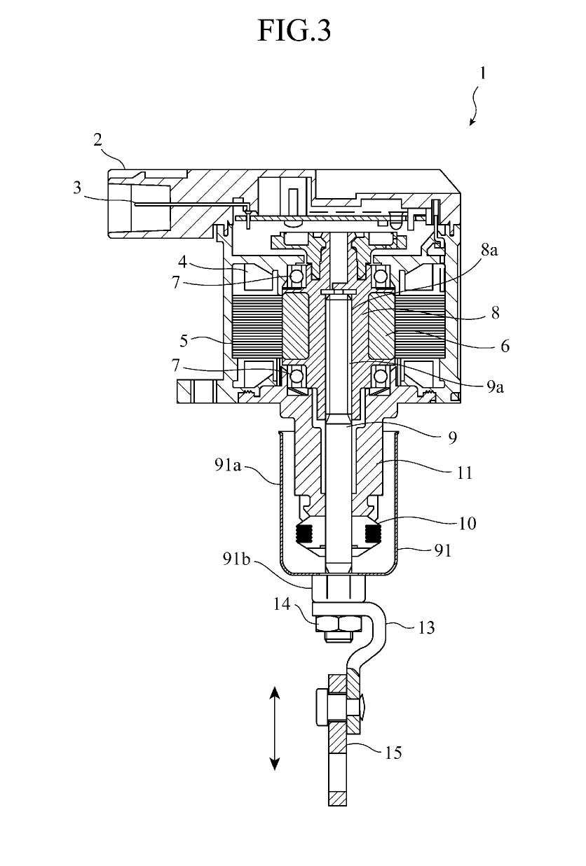

FIG. 1(a) is a sectional view showing the arrangement of a linear actuator 1 and a cover ASSY (cover) 12 attached to a shaft 9 of the actuator according to a first embodiment of the present invention, and FIG. 1(b) is a front view of a coupling portion between the actuator 1 and a driven portion 15. In the explanation of the embodiment discussed below, the actuator 1 has the same structure as that of the actuator 1 in FIG. 3 described previously. Thus, the same parts are designated by similar numerals and explanations thereof will be omitted. Hereupon, though the actuator 1 uses an electrically controlled motor, it may be the one employing another driving scheme such as a pressure-type.

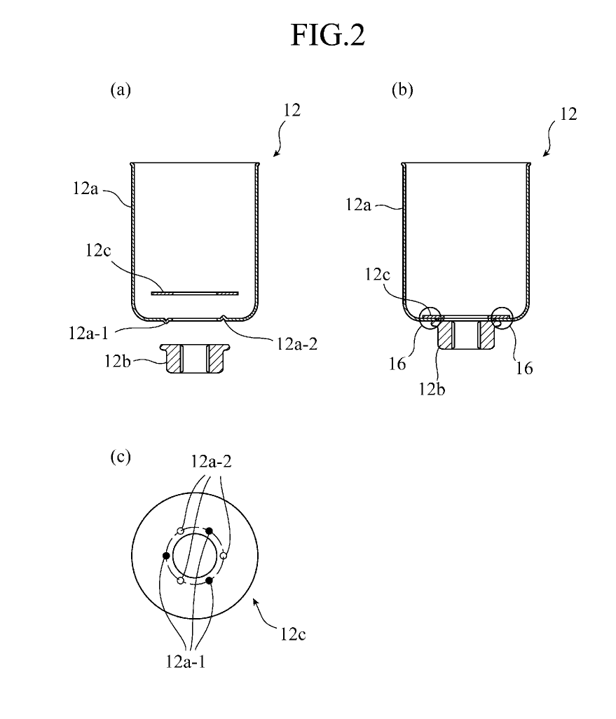

FIG. 2 shows the structure of the cover ASSY 12 according to the first embodiment: FIG. 2(a) is a sectional view showing a state before welding; and FIG. 2(b) is a sectional view showing a state after welding. The cover ASSY 12 has a structure where a bottomed cylindrical cover body 12a having a size that accommodates a boot 10 therein is projection-welded in a sandwich structure held between a general-purpose nut 12b and a plate 12c to be integrated with the nut and the plate.

For the purpose of projection-welding, projections for welding are first formed. Here, as shown in FIG. 2(a), a nut-welding protrusion 12a-1 projecting to the nut 12b side thereof and a plate-welding protrusion 12a-2 projecting to the plate 12c side thereof are formed in the cover body 12a, respectively.

Hereupon, instead of providing protrusions on the cover body 12a, it is also possible to protrusively provide a nut-welding protrusion on the side of the nut 12b that faces toward the bottom of the cover body 12a, and a plate-welding protrusion on the side of the plate 12c that faces toward the bottom of the cover body 12a. However, when the plate-welding protrusion is protrusively provided on the plate 12c, it is necessary to distinguish the front side of the plate 12c from the back side thereof upon welding of the cover ASSY 12. In contrast, when the plate-welding protrusion 12a-2 is formed on the cover body 12a as shown in FIG. 2(a), it is not required to distinguish the front side of the plate 12c from the back side thereof upon welding thereof; thus, assembly time can be reduced, and cost reduction and improvement of mass production become possible.

In addition, the nut-welding protrusion 12a-1 and the plate-welding protrusion 12a-2 each are formed by at least one. In the embodiment, in order to increase the reliability of welding, three or more nut-welding protrusions 12a-1 are formed at an equal interval on a circumference as shown in FIG. 2(c). Three or more plate-welding protrusions 12a-2 are similarly formed at an equal interval on the circumference.

Then, with the bottom portion of the cover body 12a held between the nut 12b and the plate 12c to form a sandwich structure, electric power is applied thereto during the application of pressure thereto, and each nut-welding protrusion 12a-1 and each plate-welding protrusion 12a-2 are welded thereto by resistance heat. Further, in the state after welding shown in FIG. 2 (b) , a brazing material is flown into each of mating surfaces 16 between the cover body 12a and the nut 12b, and between the cover body 12a and the plate 12c to be brazed with each other, thus further increasing the strength of the integral structure of the cover ASSY 12.

In attaching the cover ASSY 12 welded in a sandwich structure to the actuator 1, the nut 12b of the cover ASSY 12 is fastened to a male screw section 9b formed at the lower end of the shaft 9. The cover ASSY 12 protects the boot 10 made of rubber against heat and foreign matter such as stone to prevent the damage thereof. The boot 10 fills a gap between the shaft 9 and the boss 11 to prevent the entry of water, dust and the like to the interior of the actuator 1; however, the further attachment of the cover ASSY 12 brings about a labyrinth structure, thus establishing a structure for preventing the entry thereof more effectively. Hereupon, in preparation for possible entry of water into the interior of the cover ASSY 12, the cover may have a hole for draining water at the bottom thereof.

Upon driving of the actuator, the cover ASSY 12 is also translated according to the vertical translation of the shaft 9, and thus vibrations are generated in the cover ASSY 12. When the actuator 1 is of a translation-type, because of the translation-type, the cover body 12a for protecting the boot 10 has to be elongated, the whole weight of the cover ASSY 12 may also increase, and the cover ASSY also may generate large vibrations. In the embodiment, against the vibrations, the cover body 12a is held between the nut 12b and the plate 12c to thereby increase the strength with which the cover body 12a is fastened to the nut 12b, thus enabling a structure having an excellent vibration resistance. Moreover, three or more nut-welding protrusions 12a-1 and three or more plate-welding protrusion 12a-2 each are formed at an equal interval on the circumference, thus enabling the resistance of the welded mating face 16 against vibrations in any direction to be secured and enhancing the reliability thereof. Further, an implementation of brazing in addition to welding can further enhance the vibration resistance.

In this context, it is not impossible to increase the resistance to vibration by increasing the thickness of the cover body 12a or partially increasing the peripheral portion of the mating faces 16 without using the plate 12c; however, as the thickness of the whole cover body 12a is thicker, the weight of the cover ASSY 12 is increased; thus, reliability against vibrations may be reduced. Further, a partial increase of the thickness of the cover body 12a complicates the production thereof, increases the cost, and reduces the manufacturability.

As discussed above, according to the first embodiment, the cover ASSY 12 attached to the shaft 9 of the actuator 1 is arranged such that the bottom of the cover body 12a is integrated with the plate 12c and the nut 12b in a sandwich structure. On this account, the heat-shielding and screening cover ASSY 12 having the improved vibration resistance can be provided.

Further, it is arranged that the nut-welding protrusion 12a-1 is provided on the face of the cover body 12a opposite to the nut 12b, and that also the plate-welding protrusion 12a-2 is provided on the face of the cover body 12a opposite to the plate 12c. For this reason, the plate 12c has no protrusion for welding thereon; thus, since it is not required to distinguish the front face from the back face of the plate in welding, assembly time can be shortened to thus reduce the cost.

Moreover, it is arranged that three or more nut-welding protrusions 12a-1 and three or more plate-welding protrusions 12a-2 each are provided, thus enhancing the reliability thereof against vibrations in any direction.

Besides, the mating faces 16 of the cover body 12a and the nut 12b, and the mating faces 16 of the cover body 12a and the plate 12c each are brazed to each other; thereby, it is possible to further increase the vibration resistance, as compared with the case where the mating faces are only welded to each other without brazing.

Moreover, when the actuator 1 to which the cover ASSY 12 is attached is of a translation-type, because of the translation-type, the cover body 12a for protecting the boot 10 has to be elongated, thus increasing the whole weight of the cover ASSY 12 accordingly and also increasing the stress by vibrations; therefore, the cover ASSY 12 thus arranged is more effective.

Incidentally, in the first embodiment, in order to implement a sandwich structure of the cover body 12a with the nut 12b and the plate 12c, the members are integrated thereinto by welding; however, it is not limited to welding, and the members may be integrated thereinto by using adhesive, caulking, and the like.

### INDUSTRIAL APPLICABILITY

As discussed above, the cover according to the present invention has excellent vibration resistance because the bottom of the cover body is integrated into a sandwich structure using the plate and the nut, and thus the cover is suitable for use in a linear actuator or the like.

1. A cover including a nut to be screwed on a male screw section formed at an end of a shaft of an actuator; a bottomed cylindrical cover body; and a plate, wherein the bottom of the cover body is integrated with the plate and the nut in a sandwich structure.

2. The cover according to claim 1, wherein either of the opposing faces of the cover body and the plate, and either of the opposing faces of the cover body and the nut each are provided with a welding protrusion to be welded.

3. The cover according to claim 2, wherein the face of the cover body opposite to the plate, and the face of the cover body opposite to the nut each are provided with a welding protrusion.

4. The cover according to claim 3, wherein three or more welding protrusions are provided for each of the plate and the nut.

5. The cover according to claim 1, wherein the mating faces of the cover body, the plate, and the nut are brazed.

6. The cover according to claim 1, wherein the cover is attached to a linear actuator.

7. An actuator having a cover attached to a shaft, the cover comprising:
a nut to be screwed on a male screw section formed at an end of the shaft of the actuator;
a bottomed cylindrical cover body; and
a plate,
wherein the bottom of the cover body is integrated with the plate and the nut in a sandwich structure.
